(19) United States
(12) Patent Application Publication
(10) Pub. No.: US 2005/0018212 A1
(43) Pub. Date: Jan. 27, 2005

(54) Firmware patches distributable on disposable media

(76) Inventor: Eric Christensen, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/624,276

(22) Filed: Jul. 22, 2003

(51) Int. Cl. G06F 15/00

(52) U.S. Cl. 358/1.1; 358/1.16

(57) ABSTRACT

A printing device and replaceable printing device component is described. The replaceable printing device component stores a firmware patch for the printing device component. When the replaceable printing device component is coupled to the printing device, the printing device may read the firmware patch stored on the replaceable printing device component, and write the patch into the printing device firmware.

### TECHNICAL FIELD

This invention relates generally to a printing device and more particularly but not exclusively to a replaceable printing device disposable component having software to download to the printing device.

### BACKGROUND

Substantially all present-day printing devices include a computing unit having a processor, coupled memory, and a unit to accommodate a replaceable printing device component. Replaceable printing device components include for example ink containers, printheads, ink cartridges, toner cartridges and a media cartridge comprising a printable media, printhead, and ink or toner.

The printing device coupled memory includes a non-volatile section that stores a firmware routine that the processor can execute in order to perform logical printing device operations.

Printing device firmware is susceptible to being shipped with errors, as well as having a potential to benefit from enhancements. It is often difficult and expensive to upgrade existing printing device firmware to include the error fixes or enhancements.

### SUMMARY

Disclosed herein is a replaceable printing device component storing a firmware patch for a printing device. The printing device is configured to load the software patch into the printing device firmware.

### BRIEF DESCRIPTION OF THE DRAWINGS

FIG. 1 is a pictorial representation of an embodiment of a replaceable printing device component having a memory unit to store printing device firmware.

FIG. 2 is a schematic diagram of an exemplary printing device, coupled to a replaceable printing device component having associated memory.

FIG. 3 is a schematic diagram of an exemplary layout of a software object stored on the replaceable printing device component memory.

FIG. 4 is a schematic diagram of an exemplary layout of a printing device firmware patch object stored on the replaceable printing device component memory.

FIG. 5 is a flow chart portraying an exemplary printing device initialization process.

FIG. 6 is a flow chart portraying an exemplary printing device process of loading a patch from a replaceable printing device component into the printing device firmware.

### DETAILED DESCRIPTION

In the following detailed description, reference is made to the accompanying drawings which form a part hereof, and in which is shown, by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

This description describes a replaceable printing device component. A replaceable printing device component may include, for example, a component of a printing device which is insertable in, and removable from, the printing device. In one embodiment, a replaceable printing device component includes a consumable component which is disposed of and replaced, such as at an end of a useful life. An example of such a consumable component includes a printer pen, or disposable media/pen cartridge, an ink container or a toner cartridge which contain a supply of ink or other marking material for a printing device. The marking material is deposited on a print medium by the printing device, and depleted during a useful life of the ink container or the toner cartridge. As such, the ink container or the toner cartridge is disposed of, and replaced, at an end of a useful life.

In addition, a replaceable printing device component also includes a printing device component which is readily replaced in a printing device. Examples of such a printing device component include a printhead which selectively deposits ink on a print medium, or a printer cartridge which includes a printhead and an ink supply. Thus, replaceable printing device components may include an ink container, a printhead, or a printing device cartridge if, for example, a printing device includes an inkjet printing device. In addition, are placeable printing device component may include a printing device toner cartridge if, for example, a printing device includes a laser printing device.

Printer firmware patches are distributed via digital media attached to replaceable printing device components. When a user replaces a replaceable printing device component, the printing device can read the firmware patch, determine if the firmware patch is appropriate to the printing device, and apply the patch as needed. In one implementation, programmed into this digital media is data describing the firmware patches which can be used to extend or replace portions of the firmware residing in the printing device. In ore implementation, upon power on the main printer firmware checks for any firmware patches available from supplies, reads the data associated with the patches, and applies the patches appropriately.

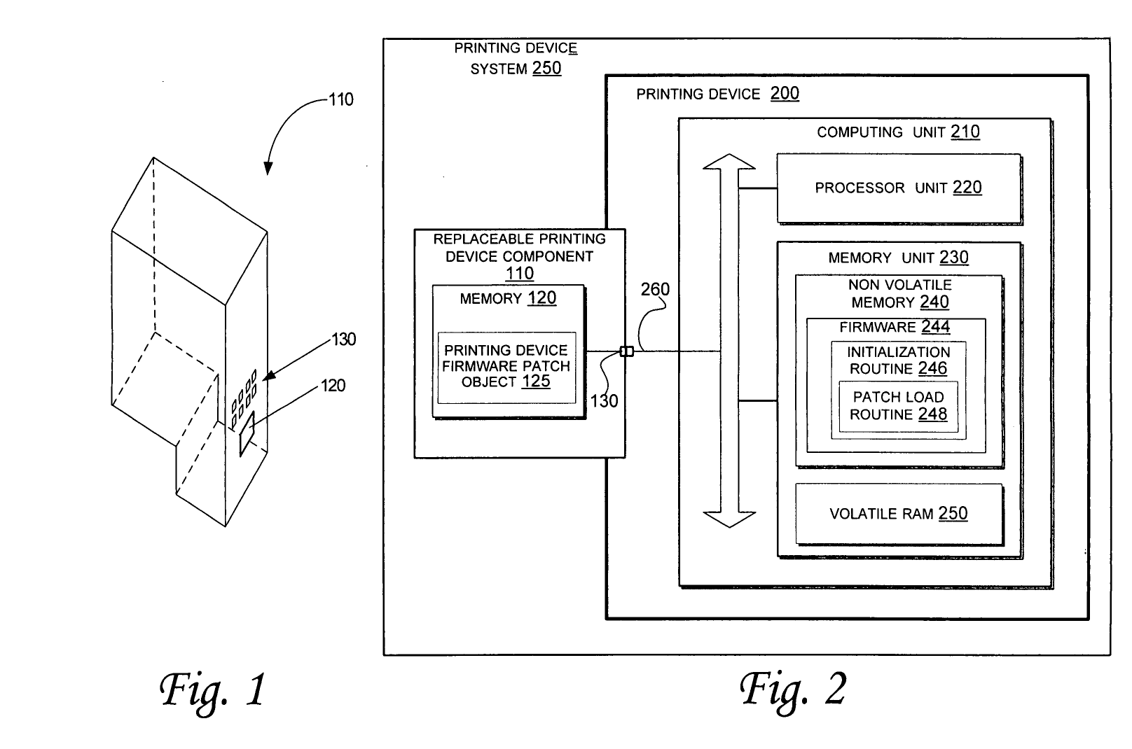

FIG. 1 illustrates one implementation of a replaceable printing device component 110. The replaceable printing device component 110 is mechanically coupleable to, and removable from, a printing device (not shown). A replaceable printing device component 110 is illustratively embodied here as an ink jet cartridge. The replaceable printing device component 110 couples to the printing device by plugging into a receptacle of the printing device, and decouples from the printing device by unplugging from the receptacle of the printing device.

The replaceable printing device component 110 has a replaceable printing device component memory 120 to store one or more software objects, including at least one printing device software patch object 125 (FIG. 2). The replaceable printing device component memory 120 is operationally coupled to terminals 130 configured to operationally couple the memory 120 to a printing device computing unit.

The printing device software patch object 125 includes a patch for the printing device firmware, as well as data describing the patch which may be used by a printing device to identify and to load the patch on the printing device. The data illustratively includes patch version applicability data, patch type data, patch size data, and/or patch start address data. Patch version applicability data refers to data indicating the printing device firmware version to which the patch applies, and which a printing device may use in determining the applicability of the patch. Patch type data refers to the data indicating the printing device storage media in which the patch is to be loaded, such as flash memory or volatile RAM memory, and which a printing device may use if the patch is specific to a printing device memory type. Both patch size and patch start address are exemplary data for use in loading the patch at a proper address space of the printing device memory.

The software objects may include the printing device software patch software object, as well as software to be used in the operation of the replaceable printing device component 110, such as ink or toner supply software to be used by the printing device to determine the amount of ink or toner stored in, or expended by, the replaceable printing device component 110. In one implementation, the ink or toner supply software includes instructions and/or data such as counters, ID fields, and other ink or toner supply information.

FIG. 2 illustrates one implementation of an exemplary printing device 200. The printing device 200 couples to a replaceable printing device component 110, illustratively portrayed as coupled or “plugged” into the printing device 200. One implementation of printing device 200 may be an inkjet printing device, and one implementation of printing device 200 may be a laser printing device. One implementation of printing device 200 may be as a standalone printing device, and one implementation of printing device 200 may be as a component of another device, such as a component of a copying device, or a facsimile device, or a network terminal device.

The printing device 200 includes a computing unit 210 that performs logical printing device operations for the printing device 200. The computing unit 210 has a processor unit 220, and a memory unit 230. The processor unit 220 includes one or more processors each capable of executing program instructions on data. The memory unit 230 includes a non-volatile memory 240 that stores the printing device processing routines (and data). The processing routines stored on the non-volatile memory 240 are termed firmware 244. Of course, even though the firmware is stored in the non-volatile memory 240, it may be executed from volatile RAM 250 after being written into volatile RAM 250, as presently described. The non-volatile memory 240 is useful for storing the printing device processing routines (and data) when the memory unit 230 is not powered. The non-volatile memory 240, such as a flash memory, is reprogrammable by the printing device.

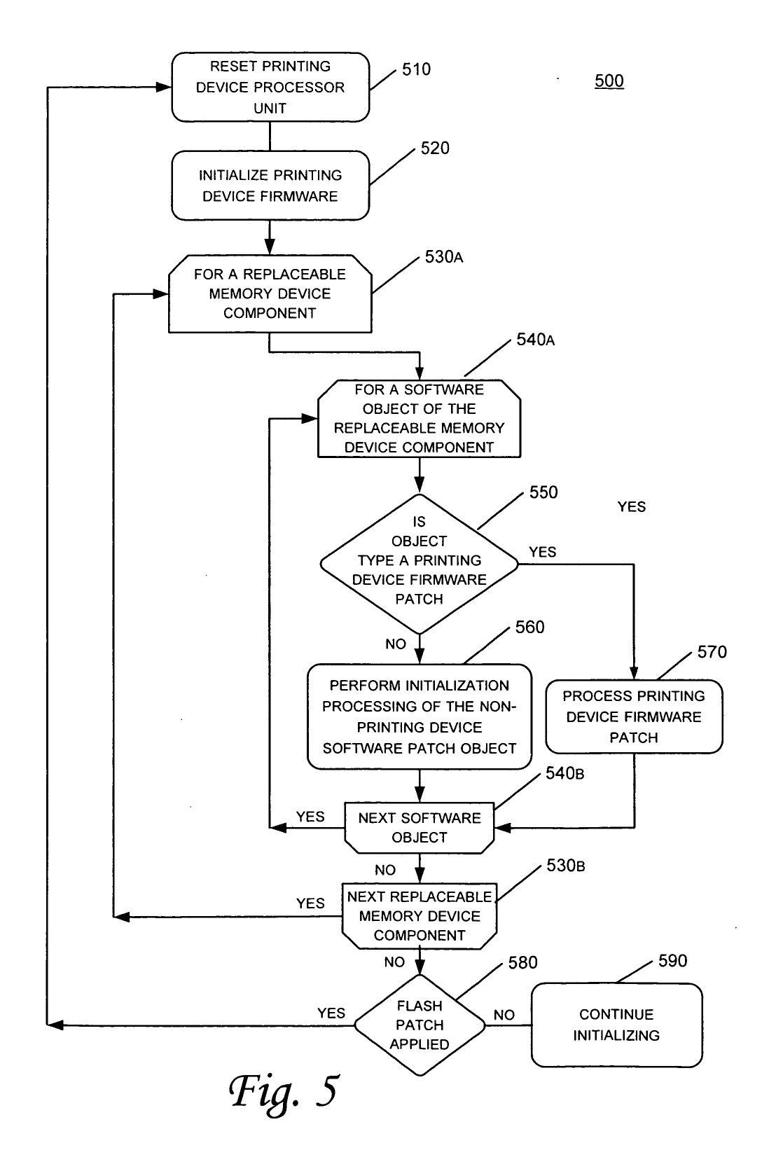

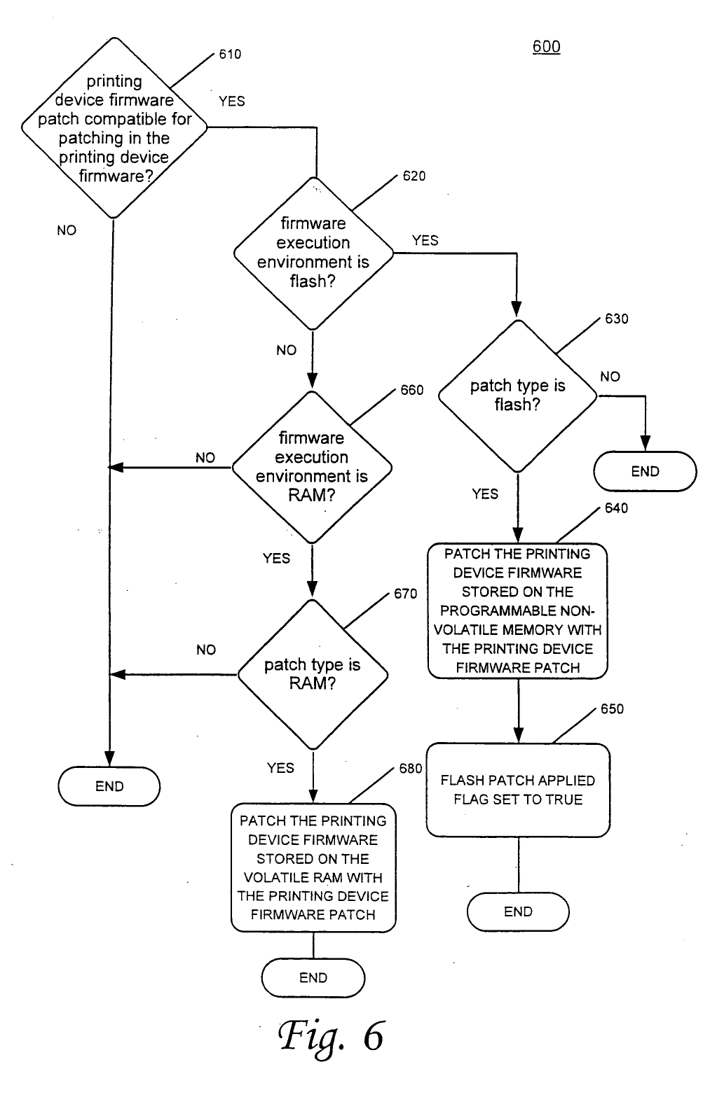

In operation of the printing device, at least a portion of the printing device processing firmware may be loaded into a volatile RAM 250 for execution from the volatile RAM 250. At least some of the printing device firmware may be stored in the non-volatile memory 240 in a compressed form, then decompressed during an initial operation of the printing device 200, and then stored in the volatile RAM 250 in its decompressed form, for execution. In one implementation, at least some of the printing device firmware may also be executed from the non-volatile memory 240. The printing device firmware 244 includes an initialization routine 246 for initializing the printing device computing unit 210 during a startup or reset of the computing unit 210. In one implementation the printing device firmware includes a patch load routine 248 to download a printing device patch from the printing device firmware patch object 125 that is stored in the coupled replaceable printing device component memory 120 into the firmware. In one implementation, the patch load routine 248 downloads the patch into a version of the firmware stored in the volatile RAM 250. In one implementation, the patch load routine 248 downloads the patch into a version of the firmware stored in the non-volatile memory 240. A description of one implementation of the initialization routine 246 is described with reference to FIG. 5. A description of one implementation of the patch load routine 248 is described with reference to FIGS. 5 and 6. The patch load routine 248 is illustratively portrayed in FIG. 2 as residing in the non-volatile memory 240, and as a component of the firmware 244 and the initialization routine 246. In one implementation, the patch load routine 248 is not a component of the initialization routine 246 (though it may be called by the initialization routine) and may be executed at times other than during the execution of the initialization routine 246. In one implementation, the patch load routine 248 is a component of the initialization routine 246. In one implementation the patch load routine 248 is executed from the non-volatile memory 240. In one implementation, the patch load routine 248 is downloaded from the non-volatile memory 230 to the volatile RAM 250, to execute from the volatile RAM 250. In one implementation, a patch load routine is stored on the replaceable printing device component memory 120 and the firmware 244 includes a routine to download the patch load routine from the printing device component memory 120 into the memory unit 230 for execution from the memory unit 230.

The replaceable printing device component 110 couples to the printing device 200, such that in operation the replaceable printing device component 110 and the printing device 200 together form a printing device system 250. Computing unit 210 and replaceable printing device component 110 communicate with each other via a printing device communication link 260 from the coupled replaceable printing device component terminals to the printing device computing unit of the printing device 200. Communication link 260 facilitates information transfer between computing unit 210 and replaceable printing device component 110 when replaceable printing device component 110 is installed in printing device 200. Communication link 260 includes, for example, an electrical transfer path, an optical transfer path, an infrared transfer path, or another information transfer path between the replaceable printing device component 110 and the computing unit 210.

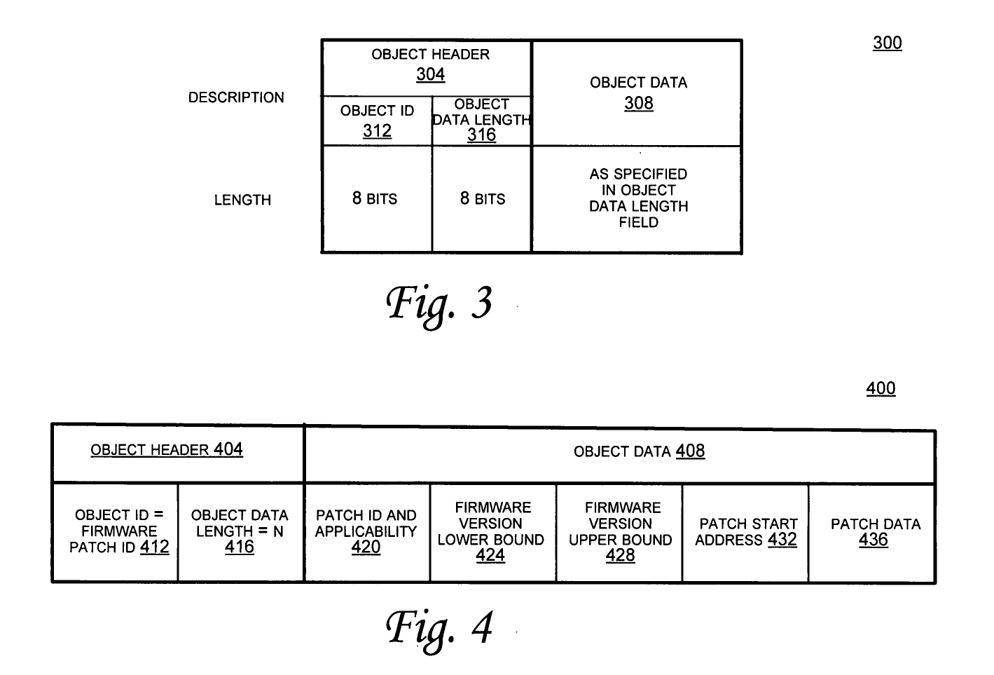

FIG. 3 portrays an exemplary software object layout 300. The length and content of the described fields are illustrative, and can be expected to vary in implementation. Moreover, because two fields (or sub-fields) are portrayed as being contiguous or having some other position relative to one another does not imply that they have that same relative position in memory. The software object includes a Header field 304, and an Object Data field 308. The Header field 304 includes an Object ID (Identification) field 312 to identify the software object. For instance, a printing device firmware patch object may have an Object ID that identifies the object as a firmware patch object, or that identifies the object as a non-firmware patch object, as described with reference to FIGS. 4 and 5. In operation, a printing device 200 may read the Object ID field 312 to determine the identification of the software object, such as to determine whether the software object is a firmware patch object. The Object Header 304 includes as well an Object Data Length field 316 to describe the quantity of bits comprising the Object Data Length field 308.

FIG. 4 portrays an exemplary printing devices firmware patch object 400 layout. The length and content of the described fields are illustrative, and can be expected to vary in implementation. Moreover, because two fields (or sub-fields) are portrayed as being contiguous or having some other position relative to one another does not imply that they have that same relative position in memory. The firmware patch object 400 comprises an Object Header field 404 and an Object Data field 408. The Object Header field 404 includes an Object ID field 412 to identify the object as a firmware patch object, such as by designating a specific bit arrangement to indicate a firmware patch object. The Object Header field 404 includes an Object Data Field length field 416 to indicate the length of the Object Data Field 408.

The Object Data field 408 includes a Patch ID and Applicability field 420. The Patch ID sub-field of the Patch ID and Applicability field 420 is to uniquely identify each firmware patch object. It is intended to be used by the printing device 200 in determining whether the identified firmware patch object has been patched into the printing device firmware on non-volatile memory. The Applicability sub-field of the Patch ID and Applicability field 420 is to indicate the memory type to which the firmware patch object is to be patched in the printing device. For instance, a printing device may be executing firmware from a non-volatile memory 240 or may be executing firmware from a volatile RAM 250, so the Applicability field is to indicate whether the firmware patch object is for either a non-volatile memory of the printing device, or for a volatile RAM of the printing device. Fields 424 and 428 together are to indicate the firmware versions to which the firmware patch object is applicable. In me implementation, the Firmware Version Lower Bound field 424 is to indicate a lower bound identification of the printing device firmware to which the firmware patch is applicable, and the Firmware Version Upper Bound field 428 is to indicate an upper bound identification of the printing device firmware to which the firmware patch is applicable. The fields 424 and 428 are intended to be used by the printing device 200 in determining whether to load the firmware patch into the printing device firmware, as described with reference to FIG. 6. The firmware patch object 400 includes data to indicate the locations in printing device memory unit 230 to load the firmware patch. Illustratively, the data includes a Patch Start Address field 432 to indicate the starting address to load the firmware patch. In this implementation, the size of the patch to download into memory unit 230 is determined from the Object Data Length field 416. The usage of the patch start field 432 is described with reference to FIG. 6.

FIG. 5 portrays an exemplary printing device initialization process 500 of initializing printing device software. In one implementation, the initialization process 500 is performed by the processor unit 220 executing the initialization routine 246 that is stored in the memory unit 230. The exemplary printing device initialization process 500 illustratively portrays a firmware patch process (block 570) as a component of the process (or the initialization routine 246). However, as described with reference to FIG. 2, in one implementation the firmware patch process is not a component of the initialization process, and may also be performed (i.e. read from the replaceable printing device component and patched into the firmware) at times other than during the printing device initialization process 500 (e.g. execution of the initialization routine 246).

Referring initially to block 510, the printing device computing unit 210 resets, setting the processor unit 220 to commence processing software at the memory location of the first instruction of the initialization routine 246, termed herein the “first instruction memory location.” In block 520, the processor unit 220 begins executing the initialization routine 246 at the first instruction memory location. The initialization routine 246 boots the printing device 200, including initializing printing device units, illustratively including initializing the volatile RAM 250. After the volatile RAM 250 is initialized, at least a portion of the firmware 240 may be copied into the volatile RAM 250, including in one implementation, the patch load routine 248, for executing from the volatile RAM 250.

Blocks 530A-530B below initialize each replaceable printing device component 110 that stores software objects. In one implementation the software objects are initially copied to the volatile RAM 250, and accessed during processing from the volatile RAM 250. In one implementation, the software objects are accessed during processing from a replaceable printing device component 110. Blocks 530A and 530B together form a looping construct. Each replaceable printing device component 110 is iteratively processed.

Each replaceable printing device component 110 is processed in blocks 540A-540B. Blocks 540A and 540B together form a looping construct in which each software object stored on a replaceable printing device component 110 is iteratively processed until each software object stored on the replaceable printing device component 110 has been processed. In block 540A, a next software object stored on the replaceable printing device component 110 is processed. In block 550, if the software object being processed is a printing device software patch, then the “YES” branch is taken in block 550 and block 570 is processed. In one implementation, each software object is identified by data in the software object, illustratively the Object ID field 312 (FIG. 3). In block 570, the firmware patch object is processed by determining whether to load the software patch in the printing device 200, and if the software patch is determined to have not been previously loaded, then loading the software patch in the printing device 200. Block 570 is performed by the process 600 portrayed in FIG. 6, and illustratively implemented by the patch load routine 248 (FIG. 2).

In block 550, if the software object being processed is not a printing device software patch, the “NO” branch is taken in block 550 and block 560 is processed. In block 560, the non-printing device software patch object is initialized. After the non-software patch object is initialized in block 560, or after the software patch object is processed in block 570, return block 540B is processed. In return block 540B, if there is a next software object to be processed, the “YES” branch is taken to process a next software object. If there is not a next software object to be processed, the “NO” branch is taken to determine a next replaceable memory device component 110 is to be processed.

In block 530B, if there is a next replaceable memory device component 110 to be processed, the “YES” branch is taken to process a next replaceable memory device component 110. If there is not a next replaceable printing device component 110 to be processed, the “NO” branch is taken. If the “NO” branch is taken from block 530B, or if a non-volatile memory patch has been loaded in block 570 FIG. 6 Block 640, the “YES” branch is taken and the printing device processor unit 220 resets. If a non-volatile memory patch has been loaded in block 570, in block 590 initializing continues.

FIG. 6 portrays an exemplary process to patch a printing device firmware patch software object stored on a replaceable printing device component into the printing device memory unit 600. The exemplary process 600 patches the firmware patch in RAM 250 if the firmware execution environment is RAM 250 and the patch type is for a RAM and patches the firmware patch in non-volatile reprogrammable memory 240 if the firmware execution environment is non-volatile reprogrammable memory 240 and the patch type is for a compatible non volatile reprogrammable memory. In one implementation, the firmware patch is patched into non-volatile reprogrammable memory regardless of the firmware execution environment if the patch type is for a compatible non-volatile reprogrammable memory, e.g. in an implementation performed before the firmware 244 is loaded into volatile RAM 250.

In block 610, if the printing device firmware patch is for patching the printing device firmware, the “YES” branch is taken to block 620. In one implementation, the printing device memory unit 230 stores data indicating the version of the printing device firmware termed the “printing device version,” and the printing device firmware patch object 125 stores data indicating the printing device firmware versions with which the patch is compatible termed the “patch compatibility data.” The printing device version is compared with the patch compatibility data to determine whether the printing device firmware patch is for patching the printing device firmware. An exemplary implementation of the printing device firmware patch object 125 storing data indicating printing device version is described with reference to FIG. 4, where the Applicability fields 424 and 428 are used indicate the applicable versions of the firmware, and the patch could be applied to versions bounded by the firmware lower bound 424 and the firmware upper bound 428. In block 610, if the printing device firmware patch is not for patching the printing device firmware, the “NO” branch is taken and the patch processing ends for this patch object In one implementation in which the process 600 is a component of, or called by, the printing device initialization process 500 (FIG. 5), processing returns to the printing device initialization process 500 (FIG. 5).

In block 620, if the firmware is executed from flash memory or other reprogrammable volatile memory, the “YES” branch is taken to block 630 for determining whether to patch the software in the flash memory (or other reprogrammable memory). In one implementation, the printing device memory unit 230 stores data indicating the memory type from which the firmware executes, and this data is used to determine whether the firmware execution environment is flash (or other reprogrammable volatile memory).

In block 630, if the patch type is for a flash (or other reprogrammable volatile memory), the “YES” branch is taken to block 640. In one implementation, this data is indicated by the Applicability sub-field of the Patch ID and Applicability field 420 (FIG. 4). In one implementation, the replaceable printing device component memory 110 stores data indicating whether the patch is for flash memory (or other reprogrammable volatile memory), and this data is used to determine whether the patch type is for flash. In block 640, the printing device firmware patch is patched into the printing device firmware stored on the flash memory (or other reprogrammable memory device). In one implementation, the replaceable printing device component memory 110 stores data to assist in locating the address at which to write the printing device firmware patch into the flash (or other reprogrammable memory). In one implementation, this data includes patch size and patch start address for use in reprogramming the firmware. In yet another implementation, this data includes the patch start address and patch end address. In one implementation, this the patch start address data is indicated by the Patch Start Address field 432 (FIG. 4), and the patch size is indicated by the Object Data Length field 416 (FIG. 4). In block 650, a flag is set to indicate that the software patch object has been patched in the firmware, for use in determining if a patch has been applied in block 580 (FIG. 5). In block 630, if the patch type is not flash (or other reprogrammable memory), the flash (or other reprogrammable memory) is not patched, and patch processing ends. In one implementation in which the process 600 is a component of, or called by, the printing device initialization process 500 (FIG. 5), processing returns to the printing device initialization process 500 (FIG. 5).

In block 620, if the firmware execution environment is not flash (or other reprogrammable memory), the “NO” branch is taken to block 660. In block 660, if the firmware is executed from volatile RAM, the “YES” branch is taken to block 670 for determining whether the patch type is for a volatile RAM. In one implementation, the printing device memory unit 230 stores data indicating the memory type from which the firmware executes, and this data is used to determine whether the firmware execution environment is volatile RAM. In block 660, if the printing device firmware patch is not executed from volatile RAM, the “NO” branch for is taken and the process 600 ends. In one implementation in which the process 600 is a component of, or called by, the printing device initialization process 500 (FIG. 5), processing returns to the printing device initialization process 500 (FIG. 5).

In block 670, if the patch type is for a volatile RAM, the “YES” branch is taken to block 680. In one implementation, the replaceable printing device component memory 110 stores data indicating whether the patch is for volatile RAM memory and this data is used to determine whether the patch type is for volatile RAM. In block 670, if the patch type is not for a volatile RAM, the “NO” branch is taken and the process 600 ends. In one implementation in which the process 600 is a component of, or called by, the printing device initialization process 500 (FIG. 5), processing returns to the printing device initialization process 500 (FIG. 5).

In block 680, the printing device firmware patch is patched into the printing device firmware stored on the volatile RAM memory. In one implementation, the replaceable printing device component memory 110 stores data to assist in locating the address at which to write the printing device firmware patch into the volatile RAM. In one implementation, this data includes patch size and patch start address for use in reprogramming the firmware. In yet another implementation, this data includes the patch start address and patch end address. In one implementation, this the patch start address data is indicated by the Patch Sort Address field 432 (FIG. 4), and the patch size is indicated by the Object Data Length field 416 (FIG. 4). After the printing device firmware is patched into the printing device firmware stored on the volatile RAM, patch processing ends. In one implementation in which the process 600 is a component of, or called by, the printing device initialization process 500 (FIG. 5), processing returns to the printing device initialization process 500 (FIG. 5).

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the resent invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A printing device system comprising:
a printing device having firmware;
a replaceable printing device component storing a firmware patch for the firmware, and coupled to the printing device; and
wherein the printing device is configured to patch the firmware patch into the firmware.

2. The printing device system defined in claim 1 wherein the replaceable printing device component comprises a memory unit, and the printing device firmware patch is stored in the memory unit.

3. The printing device system defined in claim 2 wherein the replaceable printing device component comprises terminals, the printing device comprises a computing unit and a coupled communication link, and the terminals are operable to couple to the communication link, such that the replaceable printing device component memory unit couples to the printing device computing unit.

4. The printing device system defined in claim 2 wherein the printing device comprises a computing unit that is operable to couple to the replaceable printing device component memory unit, the printing device computing unit is configured to read the memory unit, and the replaceable printing device component memory unit is configured to be read by the computing unit.

5. The printing device system defined in claim 1 wherein the replaceable printing device component is further storing data indicating where to load the firmware patch on a memory of the printing device.

6. The printing device system defined in claim 1 wherein the replaceable printing device component is further storing data identifying a type of memory on which the firmware patch is to be loaded in the printing device.

7. The printing device system defined in claim 1 wherein the replaceable printing device component is further storing data identifying a version of the firmware patch.

8. The printing device system defined in claim 1 wherein the printing device comprises a non-volatile reprogrammable memory, and the printing device is configured to patch the firmware patch on the non-volatile reprogrammable memory when the firmware is stored on the non-volatile reprogrammable memory.

9. The printing device system defined in claim 1 wherein the replaceable printing device component is further storing a patch load routine.

10. The printing device system defined in claim 1 wherein the printing device comprises a volatile RAM, and the printing device is configured to patch the firmware when the firmware is stored on the volatile RAM.

11. The printing device system defined in claim 1 wherein the printing device has a memory unit storing the firmware, and further storing instructions that cause the computing unit to patch the software patch into the firmware.

12. The printing device system defined in claim 1 wherein the printing device is configured to check for firmware patches available from the replaceable printing device component.

13. The printing device defined in claim 1 wherein the printing device is configured to read data associated with the firmware patch, and applying the firmware patch according to the data.

14. The printing device defined in claim 1 wherein the printing device is configured to verify whether the media storing the firmware is compatible with the software object.

15. The printing device defined in claim 1 wherein the replaceable printing device component stores data indicating the version of the firmware patch and the printing device is configured to verify whether the version of the firmware patch is compatible with the firmware.

16. A replaceable printing device component comprising a memory unit storing a printing device firmware patch.

17. The device defined in claim 16 further comprising terminals to couple the memory to a printing device communication link.

18. The device defined in claim 16 wherein the memory unit is configured to be read by a coupled printing device computing unit.

19. The device defined in claim 16 wherein the memory unit is further storing data identifying the firmware patch.

20. The device defined in claim 16 wherein the memory unit is further storing data indicating where to load the firmware patch on a memory of the printing device.

21. The device defined in claim 20 wherein the data indicates at least one of a size of the firmware patch, a starting address in the memory where the firmware patch is to be loaded, and an ending address in the memory where the firmware patch is to be loaded.

22. The device defined in claim 16 wherein the memory unit is further storing data identifying a type of printing device memory on which the firmware patch is to be loaded.

23. The device defined in claim 16 wherein the memory unit is further storing data identifying a version of the firmware patch.

24. The device defined in claim 16 wherein the memory unit is further storing a patch load routine.

25. A printing device comprising:
a memory unit to store firmware;
a processing unit coupled to the memory unit; and
at least one of
a patch load routine stored in the memory unit that when executed by the processor, causes the processor to perform actions comprising patching firmware stored on the memory unit from a software object stored on a coupled replaceable printing device component; and
a routine stored in the memory unit to download the patch load routine from the coupled replaceable printing device component.

26. The printing device defined in claim 25 wherein the actions further comprise checking for firmware patches available from the replaceable printing device component.

27. The printing device defined in claim 25 wherein the patching action further comprises reading data associated with the software object, and applying the software object according to the data.

28. The printing device defined in claim 27 wherein the data includes at least one of version data, printing device memory type data, and memory location on the computer readable media.

29. The printing device defined in claim 25 wherein the patching action comprises verifying whether the software object stored on the replaceable printing device component is appropriate for patching the firmware.

30. The printing device defined in claim 29 wherein the memory unit comprises media to store the firmware; and wherein the verifying action comprises verifying whether the media storing the firmware is compatible with the software object.

31. The printing device defined in claim 25 wherein the replaceable printing device component stores data indicating a version of the software object and the verifying action comprises verifying whether the version of the software object is compatible with the firmware.

32. The printing device defined in claim 25 wherein the memory unit comprises a media including at least one of a volatile RAM and a non-volatile reprogrammable memory, and the firmware to be patched is stored on the media, and wherein the patching action comprises patching the firmware on the media.

33. The printing device defined in claim 25 wherein the patching action further comprises at least one of:
patching the firmware into a reprogrammable non-volatile memory of the printing device if the firmware is to execute from the reprogrammable non-volatile memory; and
patching the firmware into a volatile RAM of the printing device if the firmware is to execute from the volatile RAM.

34. The printing device defined in claim 25 wherein the patching action further comprises reading from said replaceable printing device the printing device firmware versions to which the printing device firmware stored on the replaceable printing device component is applicable, and patching said printing device firmware only if said printing device firmware version is one of the versions to which the printing device firmware stored on the replaceable printing device component is applicable.

35. A method comprising:
coupling a replaceable printing device component to a printing device; and
patching printing device firmware stored on the replaceable printing device component into firmware of the printing device.

36. The method defined in claim 35 wherein said patching comprises patching the firmware into a reprogrammable non-volatile memory of the printing device.

37. The method defined in claim 36 further comprising resetting the printing device after the patching action.

38. The method defined in claim 35 wherein said patching comprises at least one of
patching the firmware into a reprogrammable non-volatile memory of the printing device if the firmware executes from the reprogrammable non-volatile memory; and
patching the firmware into a volatile RAM of the printing device if the firmware executes from the volatile RAM.

39. The method defined in claim 35 wherein said patching comprises reading from said replaceable printing device a printing device firmware versions to which the printing device firmware stored on the replaceable printing device component is applicable, and patching said printing device firmware only if said printing device firmware version is one of the versions to which the printing device firmware stored on the replaceable printing device component is applicable.

40. The method defined in claim 35 further comprising initializing the printing device, and wherein the initializing action comprises the patching action.

41. The method defined in claim 35 wherein said patching comprises reading the printing device firmware stored on the replaceable printing device component.

42. A computer readable media having stored thereon a routine that, when executed by at least one processor, causes the processor to perform actions comprising patching firmware stored on a printing device memory unit from a software object stored on a replaceable printing device component.

43. The computer readable media defined in claim 40 wherein the patching action further comprises reading the printing device firmware stored on the replaceable printing device component.

44. The computer readable media defined in claim 42 wherein the patching action further comprises checking for firmware patches available from the replaceable printing device component.

45. The computer readable media defined in claim 42 wherein the patching action further comprises reading data associated with the firmware patch, and applying the firmware patch according to the data.

46. The computer readable media defined in claim 42 wherein the patching action further comprises verifying whether the media storing the firmware is compatible with the software object.

47. The computer readable media defined in claim 42 wherein the patching action further comprises verifying whether the version of the firmware patch is compatible with the firmware.
